(19) United States
(12) Patent Application Publication
(10) Pub. No.: US 2026/0038030 A1
(43) Pub. Date: Feb. 5, 2026

(54) SERVER AND METHOD FOR FACILITATING BATCHING ORDERS FOR ON-DEMAND SERVICE

(71) Applicant: GRABTAXI HOLDINGS PTE. LTD., Singapore (SG)

(72) Inventors: Xinxin ZHANG, Singapore (SG); Yibo JI, Singapore (SG); Di MOU, Singapore (SG); Shengran SUN, Singapore (SG); Henokh Yernias FIBRIANTO, Singapore (SG)

(21) Appl. No.: 19/107,612

(22) PCT Filed: Mar. 21, 2024
(86) PCT No.: PCT/SG2024/050167

§ 371 Date: Feb. 28, 2025

(30) Foreign Application Priority Data
Apr. 28, 2023 (SG) 10202301190Q

(51) Int. Cl. G06Q 30/0601

(52) U.S. Cl. CPC G06Q 30/0633

(57) ABSTRACT

Aspects concern a server for facilitating batching orders of an on-demand service, the server comprising: a memory for storing instructions; a communication interface configured to receive an order for the on-demand service from a computing device; and a processor for executing the stored instructions and configured to: receive the order from the communication interface; predict an OTE (overall time efficiency) for a predetermined time slot at a predetermined area, based on a market condition signal and a batching configuration parameter; compare the predicted OTE with a predetermined OTE threshold; select a batching strategy from one or more batching strategies, based on the comparison of the predicted OTE with the predetermined OTE threshold; and attempt the selected batching strategy to batch the order with at least one other order.

### TECHNICAL FIELD

Various embodiments relate to a server and a method for facilitating batching orders for an on-demand service.

### BACKGROUND

Due to development of information technology, a user may request an on-demand service using a computing device. The on-demand service may allow the user to fulfil the user's demand via an immediate access to goods and/or services. The user may request the on-demand service, such as a delivery service or a transport service, using a user interface presented on the computing device.

To improve efficiency in providing the on-demand service, an on-demand service provider has introduced “batching”. The on-demand service provider may batch multiple orders (also referred to as “bookings”) if at least one criterion is met, and a delivery service provider (also referred to as a “driver”) may take the batched multiple orders at a time. For example, if the multiple orders are received in a same time slot and locations of the multiple orders are close to each other, such multiple orders may be batched.

However, batching may currently be executed in a sequential manner. For example, the multiple orders may be batched based on upfront batching and then be batched based on in-transit batching. This sequential batching strategy may cause inefficiency where the upfront batching is attempted even when it is suboptimal to do so, for example, when there is an insufficient nearby demand to aggregate, which leads to wasted time during a dispatching process.

Therefore, there is a need to provide a solution for facilitating batching orders for the on-demand service, in order to generate higher efficiencies.

### SUMMARY

According to various embodiments, there is a server for facilitating batching orders of an on-demand service, the server comprising: a memory for storing instructions; a communication interface configured to receive an order for the on-demand service from a computing device; and a processor for executing the stored instructions and configured to: receive the order from the communication interface; predict an OTE (overall time efficiency) for a predetermined time slot at a predetermined area, based on a market condition signal and a batching configuration parameter; compare the predicted OTE with a predetermined OTE threshold; select a batching strategy from one or more batching strategies, based on the comparison of the predicted OTE with the predetermined OTE threshold; and attempt the selected batching strategy to batch the order with at least one other order.

In some embodiments, the processor is further configured to: determine whether the predicted OTE is greater than the predetermined OTE threshold; if it is determined that the predicted OTE is greater than the predetermined OTE threshold, select a first batching strategy, and attempt upfront batching upon a receipt of the order based on the selected first batching strategy; and if it is determined that the predicted OTE is equal to or less than the predetermined OTE threshold, select a second batching strategy, and attempt in-transit batching upon the receipt of the order based on the selected second batching strategy.

In some embodiments, based on the first batching strategy, the processor is further configured to: determine that the upfront batching is attempted upon the receipt of the order; determine if a predetermined upfront pooling duration expires; and if it is determined that the predetermined upfront pooling duration expires, switch to an alternation mode that alternates between the in-transit batching or an idle allocation.

In some embodiments, based on the second batching strategy, the processor is further configured to switch to an alternation mode that alternates between the in-transit batching or an idle allocation.

In some embodiments, the processor is further configured to: start the alternation mode with tightest constraints; and gradually loosen the constraints with attempts.

In some embodiments, the processor is further configured to adjust the batching configuration parameter using the predicted OTE.

In some embodiments, the batching configuration parameter includes at least one of a batching interval, an order delivery delay, and a maximum amount of time the order can be kept.

In some embodiments, the processor is further configured to: predict an IAR (inter-arrival rate) for the predetermined time slot at the predetermined area; and use the predicted IAR as the market condition signal.

In some embodiments, the processor is configured to use an OTE predictor model to predict the OTE, and the processor is further configured to train the OTE predictor model using at least one of the predicted IAR, the predicted OTE, and the batching configuration parameter.

In some embodiments, the processor is further configured to: predict a reference OTE based on a first market condition signal and a first batching configuration parameter in a reference state, and a target OTE based on a second market condition signal and a second batching configuration parameter in a target state; and obtain a predicted OTE gain based on the predicted reference OTE and the predicted target OTE.

In some embodiments, the processor is further configured to determine the OTE threshold based on the predicted OTE gain.

According to various embodiments, there is a method for facilitating batching orders of an on-demand service, the method comprising: receiving an order for the on-demand service; predicting an OTE (overall time efficiency) for a predetermined time slot at a predetermined area, based on a market condition signal and a batching configuration parameter; comparing the predicted OTE with a predetermined OTE threshold; selecting a batching strategy from one or more batching strategies, based on the comparison of the predicted OTE with the predetermined OTE threshold; and attempting the selected batching strategy to batch the order with at least one other order.

In some embodiments, the method further comprises: determining whether the predicted OTE is greater than the predetermined OTE threshold; if it is determined that the predicted OTE is greater than the predetermined OTE threshold, selecting a first batching strategy, and attempting upfront batching upon a receipt of the order based on the selected first batching strategy; and if it is determined that the predicted OTE is equal to or less than the predetermined OTE threshold, selecting a second batching strategy, and attempting in-transit batching upon the receipt of the order based on the selected second batching strategy.

In some embodiments, the method further comprises: based on the first batching strategy, determining that the upfront batching is attempted upon the receipt of the order; determining if a predetermined upfront pooling duration expires; and if it is determined that the predetermined upfront pooling duration expires, switching to an alternation mode that alternates between the in-transit batching or an idle allocation.

In some embodiments, the method further comprises: based on the second batching strategy, switching to an alternation mode that alternates between the in-transit batching or an idle allocation.

In some embodiments, the method further comprises: starting the alternation mode with tightest constraints; and gradually loosening the constraints with attempts.

In some embodiments, the method further comprises adjusting the batching configuration parameter using the predicted OTE.

In some embodiments, the batching configuration parameter includes at least one of a batching interval, an order delivery delay, and a maximum amount of time the order can be kept.

In some embodiments, the method further comprises: predicting an IAR (inter-arrival rate) for the predetermined time slot at the predetermined area; and using the predicted IAR as the market condition signal.

In some embodiments, the predicting an OTE comprises using an OTE predictor model to predict the OTE, and the method further comprises training the OTE predictor model using at least one of the predicted IAR, the predicted OTE, and the batching configuration parameter.

In some embodiments, the method further comprises: predicting a reference OTE based on a first market condition signal and a first batching configuration parameter in a reference state, and a target OTE based on a second market condition signal and a second batching configuration parameter in a target state; and obtaining a predicted OTE gain based on the predicted reference OTE and the predicted target OTE.

In some embodiments, the method further comprises determining the OTE threshold based on the predicted OTE gain.

According to various embodiments, a data processing apparatus configured to perform the method of any one of the above embodiments is provided.

According to various embodiments, a computer program element comprising program instructions, which, when executed by one or more processors, cause the one or more processors to perform the method of any one of the above embodiments is provided.

According to various embodiments, a computer-readable medium comprising program instructions, which, when executed by one or more processors, cause the one or more processors to perform the method of any one of the above embodiments is provided. The computer-readable medium may include a non-transitory computer-readable medium.

### BRIEF DESCRIPTION OF THE DRAWINGS

The invention will be better understood with reference to the detailed description when considered in conjunction with the non-limiting examples and the accompanying drawings, in which:

FIG. 1 illustrates an infrastructure of a system including a server for facilitating batching orders for an on-demand service according to various embodiments.

FIG. 2 illustrates a block diagram of a server for facilitating batching orders for an on-demand service according to various embodiments.

FIG. 3 illustrates a flow diagram for a method for facilitating batching orders for an on-demand service according to various embodiments.

FIG. 4 illustrates a block diagram showing predicting an OTE (overall time efficiency) according to various embodiments.

FIG. 5 illustrates a block diagram showing training an OTE predictor model according to various embodiments.

FIG. 6 illustrates a block diagram showing predicting an OTE gain according to various embodiments.

FIG. 7 illustrates an example diagram showing an area performance according to various embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of a server and a method are analogously valid for the other server and method. Similarly, embodiments described in the context of a server are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

Throughout the description, the term “module” may be understood as an application specific integrated circuit (ASIC), an electronic circuit, a combinational logic circuit, a field programmable gate array (FPGA), a processor which executes code, other suitable hardware components which provide the described functionality, or any combination thereof. The term of “module” may include a memory which stores code executed by the processor.

In the following, embodiments will be described in detail.

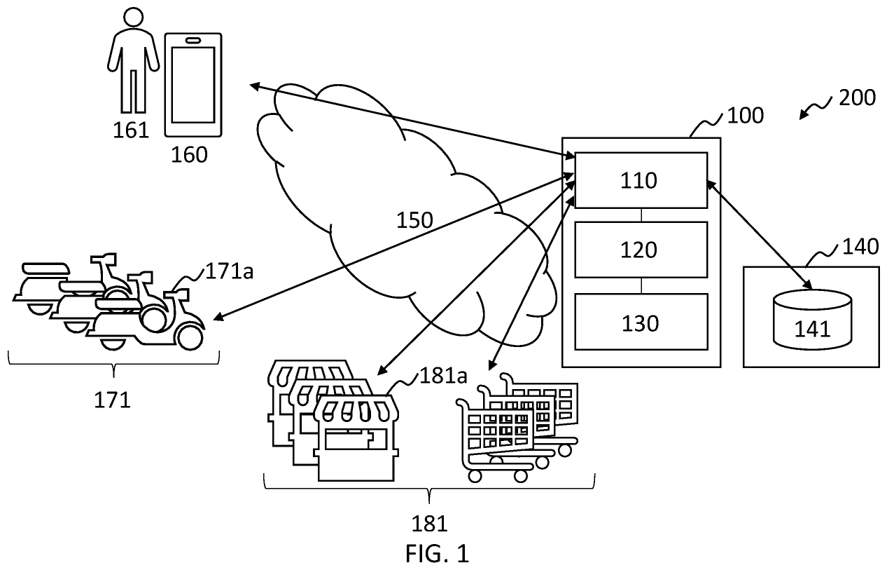

FIG. 1 illustrates an infrastructure of a system 200 including a server 100 for facilitating batching orders for an on-demand service according to various embodiments.

As shown in FIG. 1, the system 200 may include, but is not limited to, the server 100, a database system 140, a network 150, a computing device 160, and one or more external devices 170, 180 (not shown).

In some embodiments, the on-demand service may be a service allowing a user 161 (also referred to as a “consumer” or an “eater”) to fulfil the user's demand via an immediate access to items and/or services. The user 161 may request the on-demand service, such as a transport service or an item delivery service, using a user interface presented on the computing device 160. The user 161 may make an order for the on-demand service.

In some embodiments, the network 150 may include, but is not limited to, a Local Arca Network (LAN), a Wide Arca Network (WAN), a Global Arca Network (GAN), or any combination thereof. The network 150 may provide a wireline communication, a wireless communication, or a combination of the wireline and wireless communication between the server 100 and the computing device 160, and between the server 100 and the one or more external devices 170, 180, for example, one or more delivery service provider devices 170, and one or more item provider devices 180.

In some embodiments, the computing device 160 may be connectable to the server 100 via the network 150. In some embodiments, the computing device 160 may be arranged in data or signal communication with the server 100 via the network 150. In some embodiments, the computing device 160 may include, but is not limited to, at least one of the following: a mobile phone, a tablet computer, a laptop computer, a desktop computer, a head-mounted display and a smart watch. In some embodiments, the computing device 160 may be associated with the user 161. For example, the computing device 160 may belong to the user 161. Although not shown, it may be appreciated that the system 200 may further include a plurality of computing devices each associated with, for example, belonging to, a plurality of users.

In some embodiments, the computing device 160 may include a location sensor. In some embodiments, the location sensor may communicate with at least one of a global positioning satellite (GPS) server, a network server, and a Wi-Fi server, to detect a location of the computing device 160. In some embodiments, the computing device 160 may generate information about the location of the computing device 160.

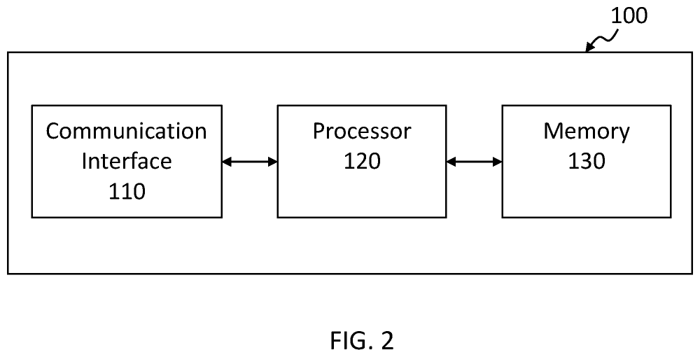

In some embodiments, the server 100, for example, implemented by a server computer, may include a communication interface 110, a processor 120, and a memory 130 (as will be described with reference to FIG. 2).

In some embodiments, the server 100 may communicate with the computing device 160 via the network 150. In some embodiments, the computing device 160 may receive a request (hereinafter, referred to as an “order”) from the user 161 for the on-demand service. The computing device 160 may send the order to the server 100 via the network 150. In some embodiments, the computing device 160 may send the information about the location of the computing device 160 to the server 100 via the network 150. The location of the computing device 160 may be considered as a location of the user 161.

In some embodiments, the system 200 may further include a database 141. In some embodiments, the database 141 may be a part of the database system 140 which may be external to the server 100. The server 100 may communicate with the database 141. In some other embodiments, although not shown, the database 141 may be implemented locally in the memory 130 of the server 100.

In some embodiments, the server 100 may communicate with the one or more external devices 170, for example, the one or more delivery service provider devices 170, via the network 150. The one or more delivery service provider devices 170 may be associated with one or more delivery service providers 171 respectively. For example, the one or more delivery service provider devices 170 may belong to the one or more delivery service providers 171 respectively. The one or more delivery service providers 171 may include, but are not limited to, a delivery partner, who can provide a delivery service from a first location, for example, a location of a selected item provider 181a, to a second location, for example, a delivery location such as a location of the user 161.

In some embodiments, the one or more delivery service providers 171 may take two or more orders which meet at least one criterion (also referred to as “batched orders”). In some embodiments, the server 100 may receive a plurality of orders from the plurality of computing devices. The server 100 may batch the two or more orders which meet the at least one criterion. For example, if the two or more orders are received in a same time slot (for example, a predetermined time slot (e.g. 5 minutes)) and locations of the two or more orders are close to each other (for example, within a predetermined distance), the server 100 may batch the two or more orders, and assign the batched orders to one delivery partner. The delivery partner may take the batched orders at a time. For example, the delivery partner may pick up a first item from a first location, for example, a location of a first item provider 181a, and pick up a second item from a third location, for example, a location of a second item provider 181b, before delivering the first item to a second location, for example, a location of a first user 161a. The delivery partner may then deliver the first item to the second location, for example, the location of the first user 161a, and deliver the second item to a fourth location, for example, a location of a second user 161b (as will be described with reference to FIG. 2).

In some embodiments, the server 100 may communicate with the one or more external devices 180, for example, the one or more item provider devices 180, via the network 150. The one or more item provider devices 180 may be associated with one or more item providers 181 respectively. For example, the one or more item provider devices 180 may belong to the one or more item providers 181 respectively. The one or more item providers 181 may include, but are not limited to, a food provider and a goods provider, that can manufacture and/or provide items, for example, foods or goods. For example, the food provider may include, but is not limited to, a restaurant and a café. As an example, the goods provider may include, but is not limited to, a store, a market, and a supermarket. In some embodiments, the server 100 may receive the order for the item delivery service with the information about the location of the user 161, and then produce a list of items, associated with at least one item provider, which can be prepared and delivered to the user 161. In some embodiments, the server 100 may communicate with the one or more item provider devices 180 to check the one or more item providers' 181 availability. In some embodiments, the server 100 may communicate with the one or more item provider devices 180 to aggregate information including, but not limited to, a list of available items, an estimated time of preparation of each item, and an estimated price of each item, in order to produce the list of items. In some embodiments, the computing device 160 may display the list of items with the aggregated information of the at least one of the one or more item providers 181 on the user interface. In some embodiments, after the user 161 makes selections on the user interface for the order for the item delivery service, for example, by selecting the item provider 181a and the item, the server 100 may communicate with an item provider device 180a (not shown) of the selected item provider 181a to prepare the selected item.

FIG. 2 illustrates a block diagram of a server 100 for facilitating batching orders for an on-demand service according to various embodiments.

As shown in FIG. 2, the server 100, for example, implemented by a server computer, may include a communication interface 110, a processor 120, and a memory 130.

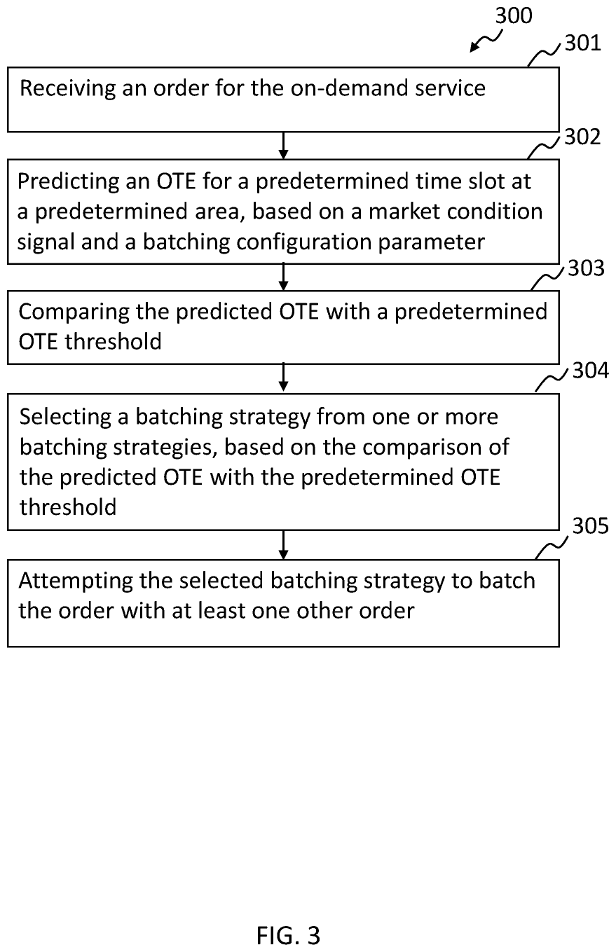

In some embodiments, the memory 130 (also referred to as a “database”) may store input data and/or output data temporarily or permanently. In some embodiments, the memory 130 may store program code which allows the server 100 to perform a method 300 (as will be described with reference to FIG. 3). In some embodiments, the program code may be embedded in a Software Development Kit (SDK). The memory 130 may include an internal memory of the server 100 and/or an external memory. The external memory may include, but is not limited to, an external storage medium, for example, a memory card, a flash drive, and a web storage.

In some embodiments, the communication interface 110 may allow one or more computing devices, including a computing device 160, to communicate with the processor 120 of the server 100 via a network 150, as shown in FIG. 1. In some embodiments, as shown in FIG. 1, the computing device 160 may belong to a user 161 who wants to make an order for an on-demand service. In some embodiments, the communication interface 110 may transmit signals to the computing device 160, and/or receive signals from the computing device 160 via the network 150.

In some embodiments, the communication interface 110 may allow one or more external devices 170, 180, for example, one or more delivery service provider devices 170, and one or more item provider devices 180, to communicate with the processor 120 of the server 100 via the network 150, as shown in FIG. 1. In some embodiments, the communication interface 110 may transmit signals to the one or more external devices 170, 180, and/or receive signals from the one or more external devices 170, 180, via the network 150.

In some embodiments, the communication interface 110 may receive an order for an on-demand service, for example, an item delivery service to be provided to the user 161, from the computing device 160 associated with the user 161 via the network 150. In some embodiments, the order for the item delivery service may include information about at least one selected item and at least one selected item provider providing the at least one selected item. The communication interface 110 may then send the order for the item delivery service to the processor 120.

In some embodiments, the communication interface 110 may further receive information about a location of the computing device 160 from the computing device 160 via the network 150. The communication interface 110 may then send the information about the location of the computing device 160 to the processor 120.

In some embodiments, the communication interface 110 may receive concurrently the order for the item delivery service and the information about the location of the computing device 160 from the computing device 160 via the network 150. In some other embodiments, the communication interface 110 may receive the order for the item delivery service first, and subsequently receive the information about the location of the computing device 160, from the computing device 160 via the network 150.

The processor 120 may include, but is not limited to, a microprocessor, an analogue circuit, a digital circuit, a mixed-signal circuit, a logic circuit, an integrated circuit, a Central Processing Unit (CPU), a Graphics Processing Unit (GPU), a Digital Signal Processor (DSP), a Field Programmable Gate Array (FPGA), an Application Specific Integrated Circuit (ASIC), or any combination thereof. Any other kind of implementation of the respective functions, which will be described below in further detail, may also be understood as the processor 120.

In some embodiments, the processor 120 may be connectable to the communication interface 110. In some embodiments, the processor 120 may be arranged in data or signal communication with the communication interface 110 to receive the order for the item delivery service and the information about the location of the computing device 160.

In some embodiments, the processor 120 may receive concurrently the order for the item delivery service and the information about the location of the computing device 160 from the communication interface 110. In some other embodiments, the processor 120 may receive the order for the item delivery service first, and subsequently receive the information about the location of the computing device 160 from the communication interface 110.

In some embodiments, the processor 120 may receive a request for a search for the item delivery service from the computing device 160. In some embodiments, the processor 120 may produce a list of items, associated with at least one item provider, which can be prepared and delivered to the user 161. The processor 120 may then provide the list of items to the computing device 160, so that the user 161 may select the item provider 181a and the item for the item delivery service.

In some embodiments, the user 161 may select the item provider 181a and the item from the list of items. The computing device 160 may generate information about the selected item provider 181a and the selected item, based on the user's 161 input. The processor 120 may receive the information about the selected item provider 181a and the selected item from the computing device 160, via the communication interface 110. In some embodiments, the processor 120 may then provide the information about the selected item to the selected item provider 181a for preparing the selected item, via the communication interface 110.

In some embodiments, the processor 120 may select a delivery service provider 171a from one or more delivery service providers 171 based on a geographical location of the one or more delivery service providers 171. In some embodiments, the processor 120 may request the selected delivery service provider 171a to pick up the selected item at a geographical location of the selected item provider 181a and deliver the selected item to the user 161.

In some embodiments, the processor 120 may receive a plurality of orders from a plurality of computing devices each associated with a plurality of users, and the processor 120 may batch two or more orders which meet the at least one criterion among the plurality of orders. For example, if the two or more orders are received in a same time slot (for example, a predetermined time slot (e.g. 5 minutes)) and locations of the two or more orders are close to each other (for example, within a predetermined distance), the processor 120 may batch the two or more orders, and assign the batched orders to the selected delivery service provider 171a. In some embodiments, the locations of the two or more orders may include pick-up locations of the two or more orders (for example, locations of item providers 181 of the two or more orders) and/or delivery locations of the two or more orders.

In some embodiments, the processor 120 may determine a delivery route of the selected delivery service provider 171a. For example, the processor 120 may determine the delivery route of the selected delivery service provider 171a based on pick-up locations and delivery locations of the batched orders. In some embodiments, the processor 120 may provide the delivery route of the selected delivery service provider 171a to a delivery service provider device 170a associated with the selected delivery service provider 171a. In some embodiments, the processor 120 may provide the delivery route of the selected delivery service provider 171a to computing devices each associated with users who made the batched orders.

In some embodiments, the selected delivery service provider 171a may take the batched orders at a time. For example, the selected delivery service provider 171a may pick up a first item from a first location, for example, a location of a first item provider 181a, and pick up a second item from a third location, for example, a location of a second item provider 181b, before delivering the first item to a second location, for example, a location of a first user 161a. The selected delivery service provider 171a may then deliver the first item to the second location, for example, the location of the first user 161a, and deliver the second item to a fourth location, for example, a location of a second user 161b.

In some embodiments, the processor 120 may predict (or expect) an OTE (overall time efficiency) for a predetermined time slot at a predetermined area, based on a market condition signal and a batching configuration parameter. In some embodiments, the OTE may refer to a signal relating to a system overall time efficiency. For example, the OTE may be predicted using a polynomial model. As an example, a mathematical equation for the polynomial model which has 12 input variables and 1 output variable (y_pred) to predict the OTE may be as follows:

$${y}_{p r e d} = a * x 1 + b * x {1}^{2} + c * x 1 * x 2 + d * x 1 * x 3 + … + e * x {2}^{2} + f * x 2 * x 3 + … + z * x {12}^{2}$$

Where x1, x2, . . . , x12 are the input variables, and a, b, . . . , z are model parameters.

In some embodiments, the processor 120 may use an OTE prediction model to predict the OTE. In some embodiments, the batching configuration parameter may include at least one of a batching interval, an order delivery delay, and a maximum amount of time the order can be kept (also referred to as a “max pooling duration”). In some embodiments, the processor 120 may predict an IAR (inter-arrival rate) for the predetermined time slot at the predetermined area. The processor 120 may use the predicted IAR as the market condition signal. In some embodiments, the OTE prediction model may obtain the batching configuration parameter and the market condition signal, and predict the OTE.

In some embodiments, the OTE prediction may apply for upfront batching. In some embodiments, the processor 120 may predict the OTE from the upfront batching, for the predetermined time slot at the predetermined area, based on the market condition signal and the batching configuration parameter. In some other embodiments, the OTE prediction may apply for in-transit batching. In some embodiments, the processor 120 may predict the OTE from the in-transit batching, for the predetermined time slot at the predetermined area, based on the market condition signal and the batching configuration parameter.

In some embodiments, the processor 120 may use the predicted OTE (also referred to as an “expected OTE”), for example, the predicted OTE signal, which takes an IAR (inter-arrival rate) of orders at a geohash level alongside an estimated efficiency uplift of the upfront batching and returns a response.

In some other embodiments, the processor 120 may predict the OTE at a batching strategy level instead. For example, the processor 120 may predict an OTE gain in case the upfront batching is used and the in-transit batching is used (for example, upfront batching vs. in-transit batching).

In some embodiments, the OTE prediction model may provide the predicted OTE, for example, the predicted OTE signal, as a function of a demand density and a batching system configuration. In some embodiments, the predicted OTE may allow to make a more informed decision when shaping a demand or tweaking batching related parameters including the batching configuration parameter (for example, discounted offers, a shorter/longer delivery SLA (Service Level Agreement)).

In some embodiments, maintaining a high quality and a cost-efficient service by leveraging batching may require accurate understanding of how a change in market conditions and tweaks in the batching system configuration affect important metrics that reflect the batching-related service quality which is primarily measured as the OTE. A few examples of features and/or products that may leverage batching in this context include as follows:
Wave-spot offer (The wave-spot offer may refer to a delivery fee discount based on the user's (eater's) sensitivity to promotion, network and maximum capacity to fulfil and the likelihood for an order to be batched)
   Given a current demand density (for example, real-time IAR), what the predicted OTE uplift will be, if a certain set of users (for example, eaters) are offered and taken the wave-spot offer.
ETA-based (estimated time of arrival-based) delivery option
   Given a predicted demand density, what the predicted OTE uplift will be, if a certain percentage (X %) of users (for example, eaters) are going to take a saver option at a certain time window (also referred to as a “certain time slot”) and area.
Contextual batching strategy
   Given the current demand density (for example, real-time IAR), what the OTE change will be, if orders arc sent for the in-transit batching directly instead of going through the upfront batching. For example, if an order is expected to have a low OTE (for example, an OTE equal to or less than an OTE threshold), then the server 100 or an operator of the server 100 may want to just release the order quickly, hoping that the order will get batched in transit along the way. In some embodiments, the processor 120 may provide a better solution, by adding another component which may predict an OTE gain from the in-transit batching, and comparing an output of that (i.e. the predicted OTE gain from the in-transit batching) with a predicted OTE gain from the upfront batching.

The above products may currently rely on various signals as a proxy to market situation and models that consume those signals (for example, a batching probability model, and a predicted TPTH (number of trips completed by the delivery service provider (driver) per transit hour) model) which predict how different market situations affect batching related metrics, to make certain decisions (for example, whether to show a discount or a cheaper option, whether to keep the order in the server's 100 order longer to try the upfront batching instead of releasing the order immediately). This may allow the server 100 to provide an accurate signal that can predict the OTE given different market conditions and batching configuration. Because, ultimately, the more accurate the server 100 is in predicting the OTE, the better decision the server 100 or the operator of the server 100 may be able to make to realise the predicted OTE gain.

In some embodiments, the processor 120 may compare the predicted OTE with a predetermined OTE threshold. In some embodiments, the processor 120 may determine whether the predicted OTE is greater than the predetermined OTE threshold.

In some embodiments, the processor 120 may predict a reference OTE based on a first market condition signal and a first batching configuration parameter in a reference state, and a target OTE based on a second market condition signal and a second batching configuration parameter in a target state. In some embodiments, the reference state may refer to how a market condition and a batching configuration look like without any intervention, while the target state may refer to how the market condition and/or the batching configuration is expected to look like once a certain decision is made. In some embodiments, the processor 120 may obtain a predicted OTE gain (also referred to as an “expected OTE gain”) based on the predicted reference OTE and the predicted target OTE. For example, the processor 120 may obtain the predicted OTE gain using the following mathematical equation:

$$Predicted OTE gain = \frac{Target OTE - Reference OTE}{Reference OTE}$$

In some embodiments, the processor 120 may determine the OTE threshold based on the predicted OTE gain. For example, the processor 120 may determine the OTE threshold based on the predicted OTE gain which may be realised by the upfront batching. In some embodiments, if the predicted OTE gain is low, for example, if the predicted OTE gain is equal to or less than a predetermined OTE gain threshold, the server 100 may determine (or assume) that it would be better off to switch to the in-transit batching.

In some embodiments, the processor 120 may select a batching strategy from one or more batching strategies, based on the comparison of the predicted OTE with the predetermined OTE threshold. In some embodiments, if it is determined that the predicted OTE is greater than the predetermined OTE threshold, the processor 120 may select a first hatching strategy, and attempt upfront batching upon a receipt of the order based on the selected first batching strategy. If it is determined that the predicted OTE is equal to or less than the predetermined OTE threshold, the processor 120 may select a second batching strategy, and attempt in-transit batching upon the receipt of the order based on the selected second batching strategy.

In some embodiments, based on the first batching strategy, the processor 120 may determine that the upfront batching is attempted upon the receipt of the order. The processor 120 may then determine if a predetermined upfront pooling duration expires. If it is determined that the predetermined upfront pooling duration expires, the processor 120 may switch to an alternation mode that alternates between the in-transit batching or an idle allocation.

In some embodiments, based on the second batching strategy, the processor 120 may switch to an alternation mode that alternates between the in-transit batching or an idle allocation. In some embodiments, the processor 120 may start the alternation mode with tightest constraints, and gradually loosen the constraints with attempts.

In some embodiments, thereafter, the processor 120 may attempt the selected batching strategy to batch the order with at least one other order. The processor 120 may then batch the order with the at least one other order based on the selected batching strategy. In some embodiments, the processor 120 may select a delivery service provider 171a for the batched orders. The selected delivery service provider 171a may process the batched orders, for example, pick up items and deliver the items to delivery locations.

In some embodiments, the upfront batching may refer to batching several orders (bookings) together first and then allocating the batched trip to an idle delivery service provider (an idle driver) who has no job being assigned yet. The in-transit batching may refer to allocating one order to an in-transit delivery service provider (in-transit driver) who already has at least one order in his/her hand. The idle allocation may refer to allocating one order to an idle delivery service provider (an idle driver) who has no job in hand right now. In some embodiments, if it is determined that the predicted OTE is greater than the predetermined OTE threshold, the processor 120 may attempt the upfront batching to batch the order with at least one other order upon the receipt of the order. If the upfront batching is successful, the processor 120 may batch the order with the at least one other order. If the upfront batching is not successful during a predetermined time period, for example, the predetermined upfront pooling duration (the maximum amount of time the processor 120 can hold the order (booking) in the batching system to try the upfront batching), the processor 120 may switch to an alternation mode that alternates between the in-transit batching or the idle allocation. Therefore, the processor 120 may attempt the in-transit batching to batch the order with at least one other order. If the in-transit batching is not successful during the predetermined time period, for example, the predetermined upfront pooling duration, the processor 120 may attempt the idle allocation under the alternation mode. If the idle allocation is not successful during the predetermined time period, for example, the predetermined upfront pooling duration, the processor 120 may attempt the in-transit batching again, under the alternation mode. In this manner, the processor 120 may alternate between the in-transit batching and the idle allocation. After the processor 120 successfully batches the order, for example, an order received from a first user 161a, with at least one other order, for example, an order received from a second user 161b, the processor 120 may select a delivery service provider 171a. The selected delivery service provider 171a may take the batched orders at a time. For example, the selected delivery service provider 171a may pick up a first item from a first location, for example, a location of a first item provider 181a, and pick up a second item from a third location, for example, a location of a second item provider 181b, before delivering the first item to a second location, for example, a location of a first user 161a. The selected delivery service provider 171a may then deliver the first item to the second location, for example, the location of the first user 161a, and deliver the second item to a fourth location, for example, a location of a second user 161b.

In some embodiments, if it is determined that the predicted OTE is equal to or less than the predetermined OTE threshold, the processor 120 may attempt the in-transit batching to batch the order with at least one other order upon the receipt of the order. If the in-transit batching is successful, the processor 120 may batch the order with the at least one other order. If the in-transit batching is not successful during a predetermined time period (the upfront pooling duration), the processor 120 may switch to an alternation mode that alternates between the in-transit batching or the idle allocation. Therefore, the processor 120 may attempt the idle allocation to batch the order with at least one other order. If the idle allocation is not successful during the predetermined time period, the processor 120 may attempt the in-transit batching again, under the alternation mode. If the in-transit batching is not successful during the predetermined time period, the processor 120 may attempt the idle allocation again, under the alternation mode. In this manner, the processor 120 may alternate between the in-transit batching and the idle allocation. In some embodiments, the processor 120 may employ a concept of stringent efficiency thresholds that gradually loosen with attempts. In other words, the processor 120 may start the alternation mode with the tightest constraints (for example, high efficiency, a pick-up distance within a certain distance (e.g. pick-up distance <Xm)), and gradually loosen the constraints with attempts. After the processor 120 successfully batches the order, for example, an order received from a first user 161a, with at least one other order, for example, an order received from a second user 161b, the processor 120 may select a delivery service provider 171a. The selected delivery service provider 171a may take the batched orders at a time. For example, the selected delivery service provider 171a may pick up a first item from a first location, for example, a location of a first item provider 181a, and pick up a second item from a third location, for example, a location of a second item provider 181b, before delivering the first item to a second location, for example, a location of a first user 161a. The selected delivery service provider 171a may then deliver the first item to the second location, for example, the location of the first user 161a, and deliver the second item to a fourth location, for example, a location of a second user 161b.

In some embodiments, the processor 120 may adjust the batching configuration parameter using the predicted OTE (for example, discounted offers, a shorter/longer delivery SLA).

In some embodiments, the processor 120 may train the OTE predictor model using at least one of the predicted IAR, the predicted OTE, and the batching configuration parameter.

As described above, in accordance with various embodiments, based on a historical (predicted and/or real-time) OTE signal, a batching strategy to deploy may be determined. By equipping the server 100 with an awareness of a marketplace situation, the server 100 may intelligently determine whether it is better to switch to alternative batching strategies or allocation for higher efficiencies. From the perspective of the user 161, the server 100 may improve order reliability and delivery time, as some of unbatched orders may otherwise go unallocated during supply crunched periods.

FIG. 3 illustrates a flow diagram for a method 300 for facilitating batching orders for an on-demand service according to various embodiments. According to various embodiments, the method 300 for facilitating batching the orders for the on-demand service may be provided.

In some embodiments, the method 300 may include a step 301 of receiving an order for the on-demand service.

In some embodiments, the method 300 may include a step 302 of predicting an OTE (overall time efficiency) for a predetermined time slot at a predetermined area, based on a market condition signal and a batching configuration parameter. In some embodiments, the OTE may be predicted from upfront batching. In some other embodiments, the OTE may be predicted from in-transit batching.

In some embodiments, the method 300 may include a step 303 of comparing the predicted OTE with a predetermined OTE threshold.

In some embodiments, the method 300 may include a step 304 of selecting a batching strategy from one or more batching strategies, based on the comparison of the predicted OTE with the predetermined OTE threshold.

In some embodiments, the method 300 may include a step 305 of attempting the selected batching strategy to batch the order with at least one other order.

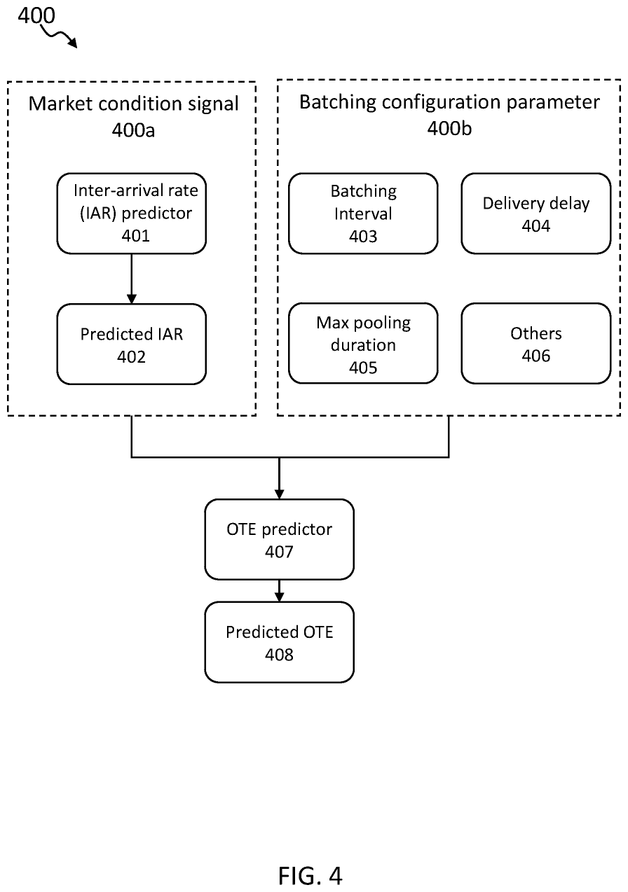

FIG. 4 illustrates a block diagram 400 showing predicting an OTE according to various embodiments. In some embodiments, the server 100 described with reference to FIG. 2 may perform operations relating to FIG. 4. In some embodiments, the server 100 may include an IAR (inter-arrival rate) predictor 401 and an OTE predictor 407 (also referred to as an “OTE prediction model”).

In some embodiments, the server 100 may use the IAR predictor 401 to obtain a market condition signal 400a. The IAR predictor 401 may predict an IAR 402, for example, for a predetermined time slot at a predetermined area. The predicted IAR 402 may be output as the market condition signal 400a.

In some embodiments, the server 100 may obtain (or collect) at least one batching configuration parameter 400b. The at least one batching configuration parameter 400b may include, but is not limited to, at least one of a batching interval 403, an order delivery delay 404, and a maximum amount of time the order can be kept (also referred to as a “max pooling duration”) 405. In some embodiments, the batching configuration parameter 400b may further include other parameter(s) 406.

In some embodiments, the server 100 may use the OTE predictor 407 to predict an OTE 408. The OTE predictor 407 may obtain the market condition signal 400a and the batching configuration parameter 400b. For example, the OTE predictor 407 may obtain the predicted IAR 402, and at least one of the batching interval 403, the order delivery delay 404, and the maximum amount of time the order can be kept 405. The OTE predictor 407 may predict the OTE 408 based on the market condition signal 400a and the batching configuration parameter 400b.

As shown in FIG. 4, the OTE predictor 407 may mainly rely on two sets of inputs, i.e. the market condition signal 400a and the batching configuration parameter 400b, and output the predicted OTE 408. In some embodiments, the predicted OTE 408 may be on an area and time period dimensions.

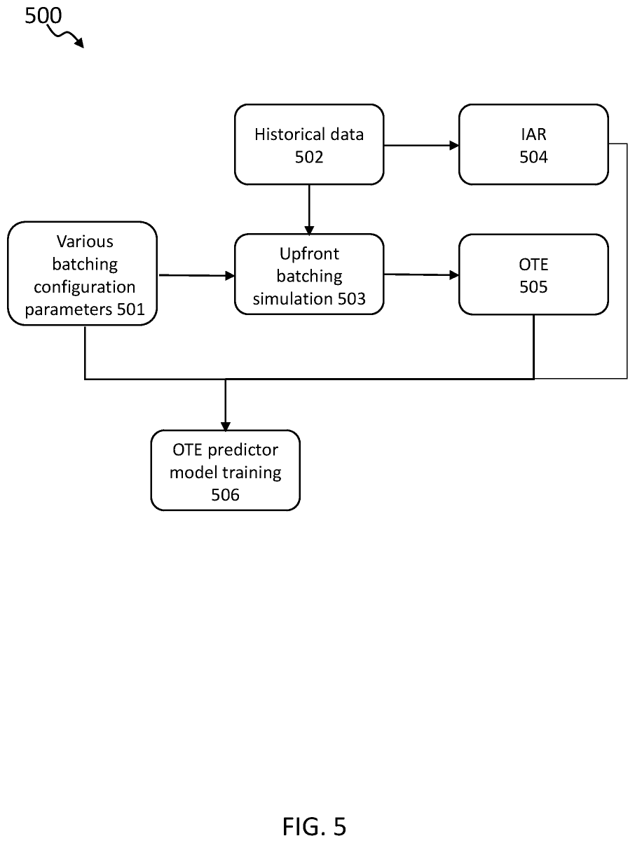

FIG. 5 illustrates a block diagram 500 showing training an OTE predictor model according to various embodiments. In some embodiments, the server 100 described with reference to FIG. 2 may perform operations relating to FIG. 5. In some embodiments, the server 100 may include an upfront batching simulator.

In some embodiments, the server 100 may train an OTE predictor model 506 using at least one of a predicted IAR, a predicted OTE, and a batching configuration parameter.

As shown in FIG. 5, in some embodiments, various batching configuration parameters 501 and historical data 502 may be fed into the upfront batching simulator for an upfront batching simulation 503. For example, the historical data 502 may include, but is not limited to, order (booking) information, such as orders' pick-up/drop-off location, order creation time, when order is estimated to be ready to pick up, and when the order is expected to be delivered. The IAR 504 may be predicted based on the historical data 502. The OTE 505 may be predicted based on the upfront batching simulation 503. The OTE predictor model 506 may be trained using the various batching configuration parameters 501, the predicted IAR 504, and the predicted OTE 505.

In some embodiments, since in a production environment, the server 100 may just have a single variant set of batching configuration parameters 501 at any given time period and area, and the OTE 505 may be affected but there are more processes other than upfront batching process, the training of the OTE predictor model 506 may mainly rely on simulation data.

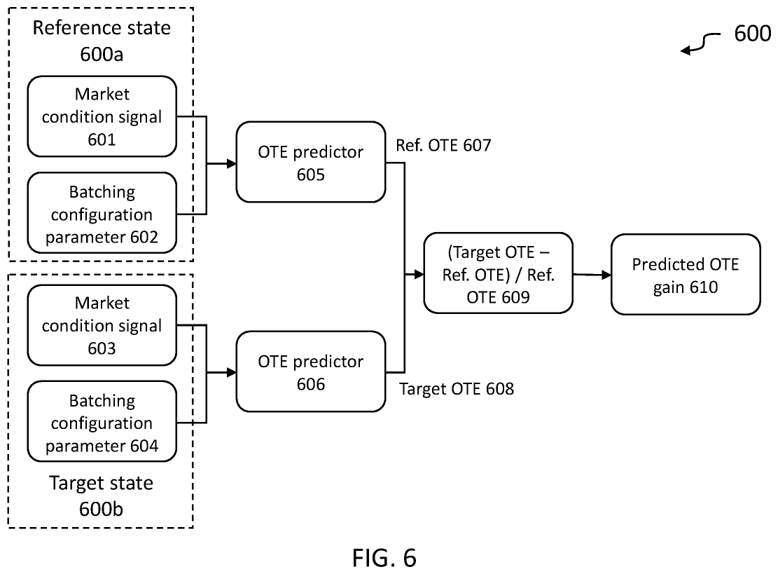

FIG. 6 illustrates a block diagram 600 showing predicting an OTE gain according to various embodiments. In some embodiments, the server 100 described with reference to FIG. 2 may perform operations shown in FIG. 6.

In some embodiments, an OTE itself may not provide much insights on how certain decisions will impact the OTE. As shown in FIG. 6, an approach utilising the OTE may be to use a predicted OTE gain 610 to evaluate an impact of a certain decision, which may be computed based on the predicted OTE 607 for a reference state 600a (hereinafter, referred to as a “reference OTE”) and the predicted OTE 608 for a target state 600b (hereinafter, referred to as a “target OTE”). In some embodiments, the reference state 600a may refer to how a market condition and a batching configuration look like without any intervention, while the target state 600b may refer to how the market condition and/or the batching configuration is expected to look like once a certain decision is made.

In some embodiments, the server 100 may predict the reference OTE 607 based on a first market condition signal 601 and a first batching configuration parameter 602 in the reference state 600a, and the target OTE 608 based on a second market condition signal 603 and a second batching configuration parameter 604 in the target state 600b. In some embodiments, a first OTE predictor 605 may predict the reference OTE 607 based on the first market condition signal 601 and the first batching configuration parameter 602 in the reference state 600a. In some embodiments, a second OTE predictor 606 may predict the target OTE 608 based on the second market condition signal 603 and the second batching configuration parameter 604 in the target state 600b. In some embodiments, the server 100 may obtain a predicted OTE gain (also referred to as an “expected OTE gain”) 610 based on the predicted reference OTE 607 and the predicted target OTE 608. In some embodiments, the server 100 may use an OTE gain calculator 609 to obtain the predicted OTE gain 610, using the predicted reference OTE 607 and the predicted target OTE 608. For example, the OTE gain calculator 609 may obtain the predicted OTE gain 610 using the following mathematical equation:

$$Predicted OTE gain = \frac{Target OTE - Reference OTE}{Reference OTE}$$

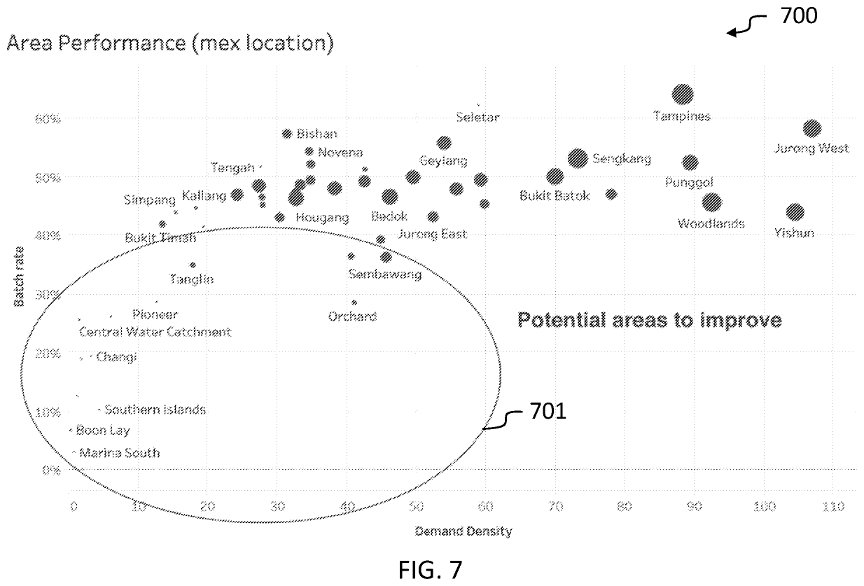

FIG. 7 illustrates an example diagram 700 showing an area performance according to various embodiments. In some embodiments, the server 100 described with reference to FIG. 2 may perform operations relating to FIG. 7.

In some embodiments, the server 100 may determine an OTE threshold based on a predicted (expected) OTE gain which may be realised by upfront batching. In some embodiments, if the predicted OTE gain is low, for example, if the predicted OTE gain is equal to or less than a predetermined OTE gain threshold, the server 100 may determine (or assume) that it would be better off to switch to in-transit batching.

In some embodiments, in determining what the OTE threshold should be, the server 100 may start by i) looking at areas that are not dense, ii) identifying corresponding upfront batching rates, and iii) comparing with a corresponding demand density and OTE values (the predicted OTE). For example, as shown in FIG. 7, areas 701 with extremely low OTE demand density compared to an average area may be used to decide the OTE threshold accordingly. By switching to the in-transit batching, the server 100 may observe increases in OTE for these areas 701.

In accordance with various embodiments, the server 100 may provide a contextual batching strategy by switching between one or more batching strategics, for example, two batching strategies. When the predicted OTE falls to or below the OTE threshold, for example, a threshold X, the server 100 may switch to a pure in-transit batching strategy. When the predicted OTE is above the threshold X, a default strategy of upfront batching followed by in-transit batching may be applied.
a) In some embodiments, for JITA (just-in-time orders)-active (for example, if it is a basic JITA) and/or JITA-effective (for example, if it is a smart JITA) orders, the contextual batching strategy may not be applied due to a high complexity and a potentially low impact. In the circumstances, a single order allocation may be handled as follows (since currently the single order/in-transit batching happens alternatively):
   i) It may be considered how to handle potential waste of DS (Data Science) resources if the in-transit batching cannot be formed at the start. Initial in-transit batching attempts may also be wasted (similar effect as order staying pooling without forming any upfront batching). For example, the DS resources may refer to computing resources allocated to solve the corresponding in-transit or upfront batching problem.
   ii) Applying the same waiting time constraint as JITA option orders in the upfront batching to the in-transit batching may not be a preferable solution, as this may yield more M×N batches, which may have low waiting time by keeping the Dax (the delivery service provider (driver)) busy travelling between pick-ups. Such batches may not be preferable for both an on-demand service provider and Dax. Although there is a separate initiative to prioritise 1×N batches, the scope may mainly be focusing on upfront batching orders (Prioritise Same-Venue Batching).
   iii) It may be considered what the impact after excluding the JITA option orders and saver option orders is.
b) In some embodiments, for the saver option orders, the contextual batching strategy may not be applied. Because, the saver option display may be based on the TPTH from the upfront batching simulation. Skipping the upfront batching for the saver option may not make sense as the predicted efficiency uplift may be supposed to be from the upfront batching. In some embodiments, a saver option logic may have a higher priority than a JITA logic. If an order is both a JITA option order and a saver option order, it may follow the saver option logic.

In accordance with various embodiments, the server 100 may use a predicted OTE (also referred to as a “predicted OTE signal”) which may forecast and determine the OTE for upfront batched orders in a given area-time level. This may allow an appropriate batching strategy to deploy.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A server for facilitating batching orders of an on-demand service, the server comprising:
a memory for storing instructions;
a communication interface configured to receive an order for the on-demand service from a computing device; and
a processor for executing the stored instructions and configured to:
receive the order from the communication interface;
predict an OTE (overall time efficiency) for a predetermined time slot at a predetermined area, based on a market condition signal and a batching configuration parameter;
compare the predicted OTE with a predetermined OTE threshold;
select a batching strategy from one or more batching strategies, based on the comparison of the predicted OTE with the predetermined OTE threshold; and
attempt the selected batching strategy to batch the order with at least one other order.

2. The server according to claim 1, wherein the processor is further configured to:
determine whether the predicted OTE is greater than the predetermined OTE threshold;
if it is determined that the predicted OTE is greater than the predetermined OTE threshold, select a first batching strategy, and attempt upfront batching upon a receipt of the order based on the selected first batching strategy; and
if it is determined that the predicted OTE is equal to or less than the predetermined OTE threshold, select a second batching strategy, and attempt in-transit batching upon the receipt of the order based on the selected second batching strategy.

3. The server according to claim 2, wherein, based on the first batching strategy, the processor is further configured to:
determine that the upfront batching is attempted upon the receipt of the order;
determine if a predetermined upfront pooling duration expires; and
if it is determined that the predetermined upfront pooling duration expires, switch to an alternation mode that alternates between the in-transit batching or an idle allocation.

4. The server according to claim 2, wherein, based on the second batching strategy, the processor is further configured to switch to an alternation mode that alternates between the in-transit batching or an idle allocation.

5. The server according to claim 4, wherein the processor is further configured to:
start the alternation mode with tightest constraints; and
gradually loosen the constraints with attempts.

6. The server according to claim 1, wherein the processor is further configured to adjust the batching configuration parameter using the predicted OTE.

7. The server according to claim 1, wherein the batching configuration parameter includes at least one of a batching interval, an order delivery delay, and a maximum amount of time the order can be kept.

8. The server according to claim 1, wherein the processor is further configured to:
predict an IAR (inter-arrival rate) for the predetermined time slot at the predetermined area; and
use the predicted IAR as the market condition signal.

9. The server according to claim 8, wherein the processor is configured to use an OTE predictor model to predict the OTE, and
the processor is further configured to train the OTE predictor model using at least one of the predicted IAR, the predicted OTE, and the batching configuration parameter.

10. The server according to claim 1, wherein the processor is further configured to:
predict a reference OTE based on a first market condition signal and a first batching configuration parameter in a reference state, and a target OTE based on a second market condition signal and a second batching configuration parameter in a target state; and
obtain a predicted OTE gain based on the predicted reference OTE and the predicted target OTE.

11. The server according to claim 10, wherein the processor is further configured to determine the OTE threshold based on the predicted OTE gain.

12. A method for facilitating batching orders of an on-demand service, the method comprising:
receiving an order for the on-demand service;
predicting an OTE (overall time efficiency) for a predetermined time slot at a predetermined area, based on a market condition signal and a batching configuration parameter;
comparing the predicted OTE with a predetermined OTE threshold;
selecting a batching strategy from one or more batching strategies, based on the comparison of the predicted OTE with the predetermined OTE threshold; and
attempting the selected batching strategy to batch the order with at least one other order.

13. The method according to claim 12 further comprising:
determining whether the predicted OTE is greater than the predetermined OTE threshold;
if it is determined that the predicted OTE is greater than the predetermined OTE threshold, selecting a first batching strategy, and attempting upfront batching upon a receipt of the order based on the selected first batching strategy; and
if it is determined that the predicted OTE is equal to or less than the predetermined OTE threshold, selecting a second batching strategy, and attempting in-transit batching upon the receipt of the order based on the selected second batching strategy.

14. The method according to claim 13 further comprising: based on the first batching strategy,
determining that the upfront batching is attempted upon the receipt of the order;
determining if a predetermined upfront pooling duration expires; and
if it is determined that the predetermined upfront pooling duration expires, switching to an alternation mode that alternates between the in-transit batching or an idle allocation.

15. The method according to claim 13 further comprising: based on the second batching strategy, switching to an alternation mode that alternates between the in-transit batching or an idle allocation.

16. The method according to claim 15 further comprising:
starting the alternation mode with tightest constraints; and
gradually loosening the constraints with attempts.

17. The method according to claim 12 further comprising adjusting the batching configuration parameter using the predicted OTE.

18. The method according to claim 12, wherein the batching configuration parameter includes at least one of a batching interval, an order delivery delay, and a maximum amount of time the order can be kept.

19. The method according to claim 12 further comprising:
predicting an IAR (inter-arrival rate) for the predetermined time slot at the predetermined area; and
using the predicted IAR as the market condition signal.

20. The method according to claim 19, wherein the predicting an OTE comprises using an OTE predictor model to predict the OTE, and
the method further comprises training the OTE predictor model using at least one of the predicted IAR, the predicted OTE, and the batching configuration parameter.
